(19) United States
(12) Patent Application Publication
(10) Pub. No.: US 2015/0136110 A1
(43) Pub. Date: May 21, 2015

(54) OUTDOOR COOKING APPARATUS

(71) Applicants: David A. Jacques, Delano, MN (US); Mark I. Jacques, Cologne, MN (US); Mark D. McMullen, Mounds View, MN (US)

(72) Inventors: David A. Jacques, Delano, MN (US); Mark I. Jacques, Cologne, MN (US); Mark D. McMullen, Mounds View, MN (US)

(73) Assignee: TOWNLINE HOLDING, INC., Delano, MN (US)

(21) Appl. No.: 14/507,075

(22) Filed: Oct. 6, 2014

Related U.S. Application Data
(62) Division of application No. 13/195,803, filed on Aug. 1, 2011, now abandoned.

(51) Int. Cl. A47J 33/00

(52) U.S. Cl. CPC A47J 33/00
USPC 126/30

(57) ABSTRACT

The outdoor cooking apparatus comprises an enclosed area defining a heat containment structure, a spine operably connected to the heat containment structure, a collar operably connected to the spine, a quick release device or hinge attachable to a collar on the spine or a spine sleeve, and at least one cooking support attached or attachable to the device or hinge. The device or hinge is adapted for efficient attachment and removal of the cooking support to and from the spine and further adapted for rotatable movement around a central vertical axis of the spine and vertical movement along a vertical length of the spine, thus allowing the user to adjust and customize the intensity of the heat on the cooking support. The cooking supports are also adapted to accommodate a plurality of cooking surfaces.

### BACKGROUND OF THE INVENTION

1. Field of the Invention

The present invention relates to an outdoor cooking apparatus, more specifically, an apparatus comprising multiple, easily attachable and detachable cooking platforms adapted for rotatable and vertical movement over, near, and away from a heat source, and a quick-release mechanism that provides quick and simple coupling and decoupling of the cooking platforms to the apparatus and serves as a rotatable hinge.

2. Description of the Prior Art

Outdoor cooking grills are well known and popular. There have been several attempts to provide cooking grills with multiple cooking platforms or rotating designs to improve the experience and flexibility of cooking outdoors. For example, U.S. Pat. No. 5,287,844 to Fieber discloses a campfire grill for cooking over an open fire with interchangeable cooking implements that can be adjusted to a desired height above a campfire. U.S. Pat. No. 5,819,718 to Leiser discloses a portable barbeque grill having a grill grate that can be adjusted vertically, horizontally, or rotated above or away a heat source. Similarly, U.S. Pat. No. 5,862,742 to Bjerg discloses cantilevered cooking grills for campfires with multiple cooking arms.

The aforementioned outdoor barbecue grills and others in the prior art typically offer limited features. Therefore, there is a further need for an outdoor cooking apparatus that combines multiple cooking platforms, rotatable and vertical movement over a heat source area, multiple cooking surfaces, and the ability to easily add or remove cooking platforms without tools.

Coupling devices or hinges are well known and many types exist in the prior art. Most types, however, are limited to solving a problem related to a specific use and not readily adaptable for other purposes. U.S. Pat. No. 1,145,759 to Dwyer discloses a hinge for use on storm doors, windows, or ordinary doors with a removable pintle. U.S. Pat. No. 3,059,271 to Ericsson discloses a hinge for supporting a door on a frame to swing about a fixed axis between open and closed positions to permit easy removal of the door from the frame.

Similarly limited is U.S. Pat. No. 2,588,271 to Morgan that discloses a disconnectable hinge for parking meter doors. U.S. Pat. No. 2,926,382 to Knese et al. discloses a quick-release hinge with a pintle for chassis arrangements of complex electronic equipment. U.S. Pat. No. 4,187,050 to Barbee discloses a quick-disconnect coupling for affixing tools like an earth-moving bucket or excavator to a powered arm. U.S. Pat. No. 5,382,110 to Perotto et al. discloses a quick coupling device adapted for attaching mining and construction tools to a boom of a carrier.

All of the aforementioned hinges, however, are limited to specific components or devices that serve to minimize their overall flexibility and usefulness. Thus, there is a need for a quick-release coupling device or hinge that can accommodate a variety of uses and provide the flexibility of multi-dimensional configuration. The outdoor cooking apparatus includes the quick-release device or hinge disclosed herein.

### BRIEF SUMMARY OF THE INVENTION

The present invention provides an outdoor cooking apparatus or grill comprising a heat source area, at least one vertically oriented spine, at least one cooking platform operably connected to the spine and adapted for rotatable and vertical movement above the heat source area, and a quick-release mechanism attachable to the cooking platform that allows a user to easily, quickly, and efficiently add or remove the cooking platform from the spine. The cooking platform further comprises a plurality of cooking surfaces.

An embodiment of the apparatus comprises steel, although other materials like cast iron may be suitable. The heat source area may comprise a fire pit further comprising circular, rectangular or hexagonal configurations comprising sections that can be assembled and disassembled to make the apparatus and fire pit portable. The heat source area also may define a perimeter that impedes horizontal movement of the heat source beyond the perimeter while allowing heat to vertically rise and warm the cooking platform. Those skilled in the art will appreciate that other shapes may be suitable and equivalent to the aforementioned configurations. An embodiment of the fire pit includes at least one anchor, preferably a plurality of anchors adapted to accommodate a spike or nail in an opening through the anchor and into the ground to secure the fire pit to the ground. Another embodiment of the fire pit comprises an overhang on the top side of the fire pit defining a circular opening. A further embodiment of the fire pit comprises a partially enclosed bottom and support legs.

The fire pit, regardless of the shape or configuration, defines a raised perimeter confining a heat source. The raised perimeter also impedes the heat source, as in the case of loose wood or charcoal, from falling or moving outside the perimeter. The heat source might include an electrical source, burning wood or charcoal, or an ignited fossil fuel like propane gas. Those skilled in the art will appreciate that other heat sources may be suitable and equivalent to the aforementioned sources.

Preferably, the apparatus includes more than one cooking platform and is made of steel, although other suitable materials may be used to construct the components of the apparatus. In a preferred embodiment, multiple cooking platforms can be adapted to vertically funnel and partially trap smoke and heat to speed cooking or create a smoking effect. The spine is adapted to engage a cooking platform and hold it in place along a vertical length of the spine. The quick-release mechanism includes a hinge design adapted to engage the spine and allows a user to add or remove cooking platforms without tools. The hinge design also allows the cooking platform to rotate around the axis of the spine allowing the user to rotate the cooking platform over or away from the heat source.

The hinge design comprises upper and lower brackets, wherein the upper bracket comprises a hook end and the lower bracket comprises an oval-shaped end. The bracket ends are adapted to engage a collar operably connected to a vertically-oriented spine. The spine essentially comprises a smooth or notched rod of a certain or adjustable length. Preferably, the collar comprises a split collar adapted for user-adjustable positioning along a select vertical length of the spine. When the collar is so positioned, the upper bracket of the device comprising the hook end engages and rests upon the collar and the lower bracket comprising the oval-shaped end rests upon the spine allowing the device to rotate around a vertical axis of the spine. The inner radial circumference of both the hook and oval-shaped ends are slightly larger than the outside circumference of the spine so the hook and oval-shaped ends can partially encircle the spine when engaged with the collar and spine.

The hinge design, as an integral component of the quick-release mechanism, may be further adapted as an attachable or attached component of a cooking support that when engaged with the collar and spine allows the attached cooking support to also rotate around a vertical axis of the spine. In an embodiment comprising a cooking support, the support may comprise a cooking surface that when positioned along a vertical axis of the spine, allows the support and surface, relative to a heat source, to be adjusted vertically away or near the heat and/or rotated away from, or above, the heat.

An embodiment of the spine comprises at least one collar perpendicular to the vertical axis of the spine. In one embodiment, the collar is a split collar that can be positioned and secured along any length of the spine. The collar is adapted to engage a upper bracket of the quick-release mechanism or hinge design. In another embodiment, the collar is an integral flange or a mated component of a sleeve with an inner diameter slightly larger than the outer diameter of the spine so it can slip over the spine and rest upon a side of the fire pit or the flange of a sleeve placed below. In this embodiment, the user may employ sleeves of different lengths to adjust the relative height of the cooking platforms above the heat source.

An embodiment of the cooking platform includes a plurality of cooking platforms and surfaces separately connectable to the spine. By way of non-limiting example only, suitable cooking surfaces include a grill, a wok, a griddle, a skillet, rotisserie, and/or a Dutch oven. The cooking platform comprises a ring, which is attached or attachable to the quick-release mechanism. The ring of the cooking platform is further adapted to comprise an inner-ring comprising a lip that traverses the inner circumference of the ring, or a plurality of smaller lips equally dispersed within the circumference of the ring, or at least one support bar traversing a chord of the ring upon which a cooking surface may securely rest within the ring.

### DESCRIPTION OF THE DRAWINGS

The invention can be better understood by reference to the following drawings, wherein:

FIG. 1 is an embodiment of a coupling device or hinge of the apparatus.

FIG. 2 is another embodiment of a coupling device or hinge of the apparatus.

FIG. 3 is a further embodiment of a coupling device or hinge of the apparatus.

FIG. 4 is another embodiment of a coupling device or hinge of the apparatus.

FIG. 5 is another embodiment of a coupling device or hinge of the apparatus.

FIG. 6 is another embodiment of a coupling device or hinge of the apparatus.

FIG. 7 is another embodiment of a coupling device or hinge of the apparatus.

FIG. 8 is an embodiment of a spine.

FIG. 9 is another embodiment of a spine.

FIG. 10 is an embodiment of a collar.

FIG. 11 is an embodiment of a heat source area and spine.

FIG. 12 is an embodiment of an outdoor cooking apparatus.

FIG. 13 is an embodiment of an outdoor cooking apparatus.

FIG. 14 is an embodiment of an outdoor cooking apparatus.

FIG. 15 is an embodiment of an outdoor cooking apparatus.

FIG. 16 is an embodiment of an outdoor cooking apparatus.

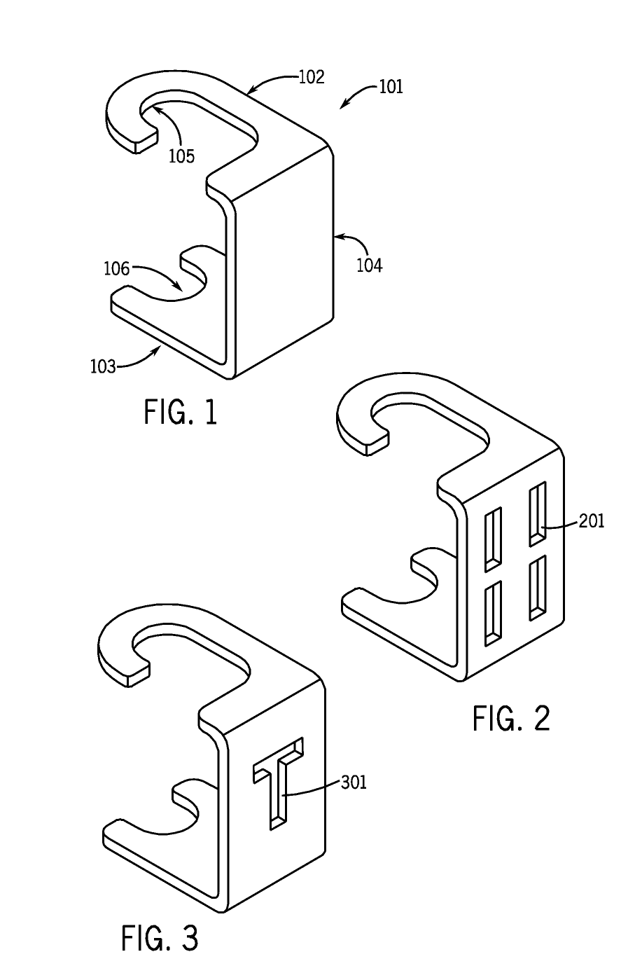

### DETAILED DESCRIPTION

In the following detailed description, the accompanying drawings show by way of illustration specific embodiments or examples. These embodiments may be combined, other embodiments may be utilized, and structural, logical, and procedural changes may be made without departing from the spirit and scope of the present invention. The following detailed description is, therefore, not to be taken in a limiting sense, and the scope of the present invention is defined by the appended claims and their equivalents.

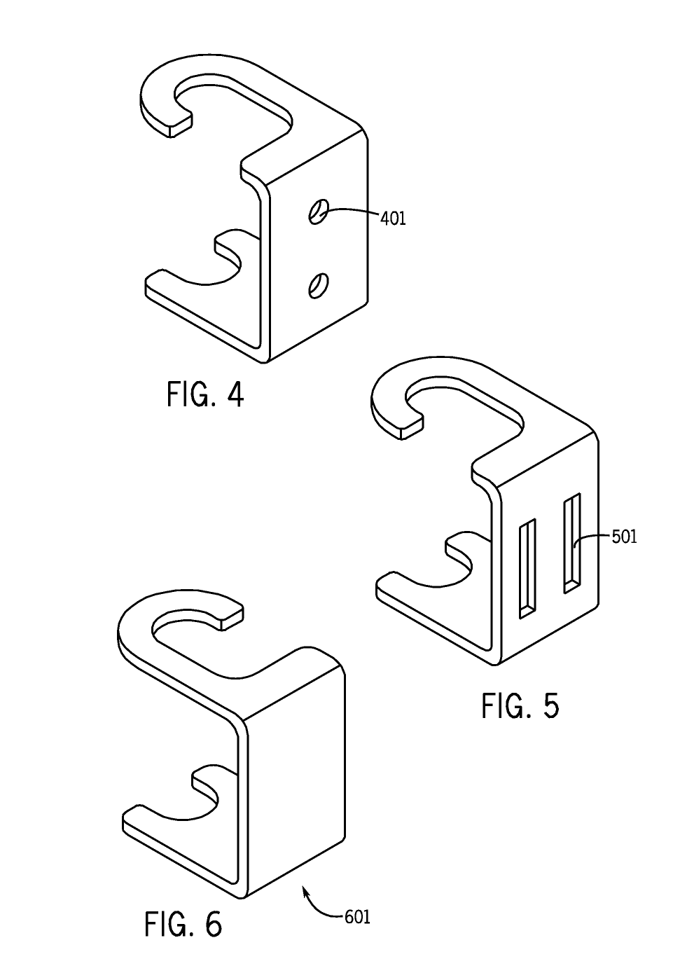

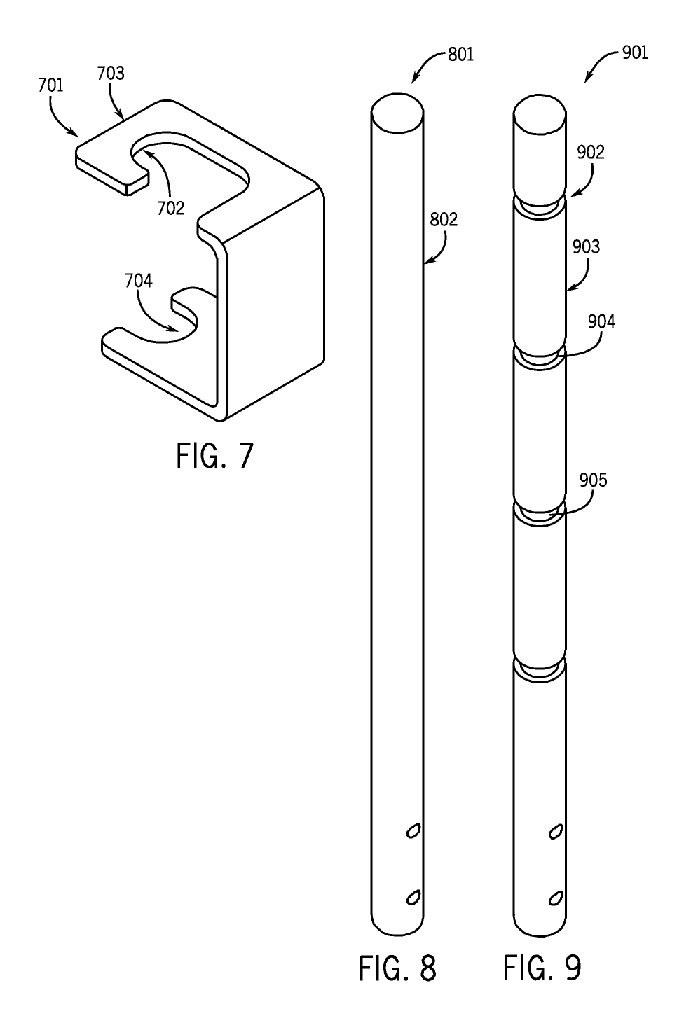

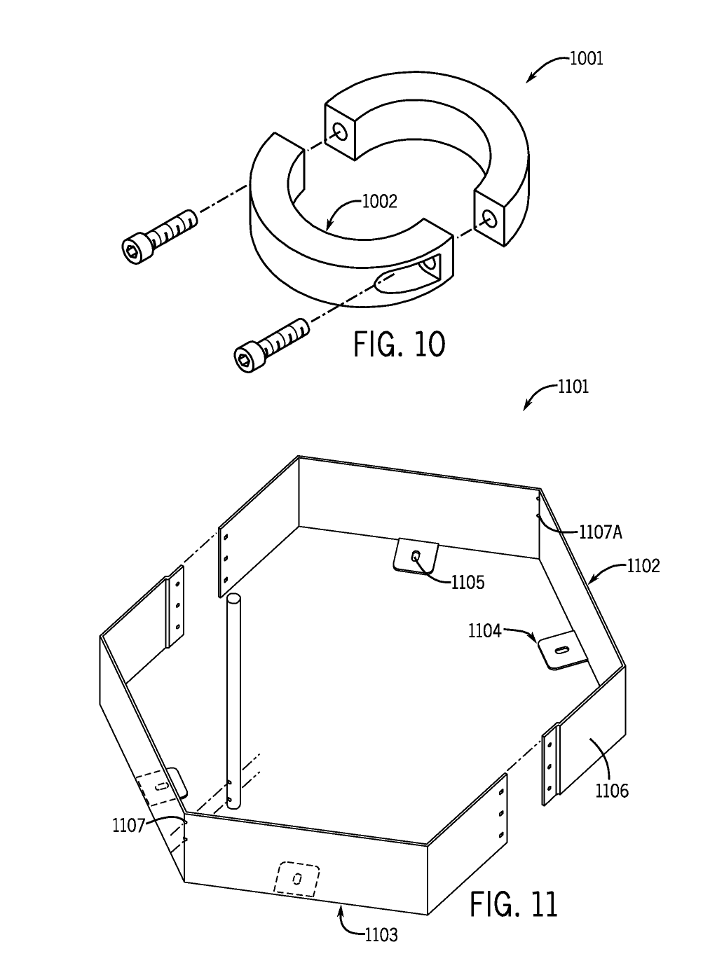

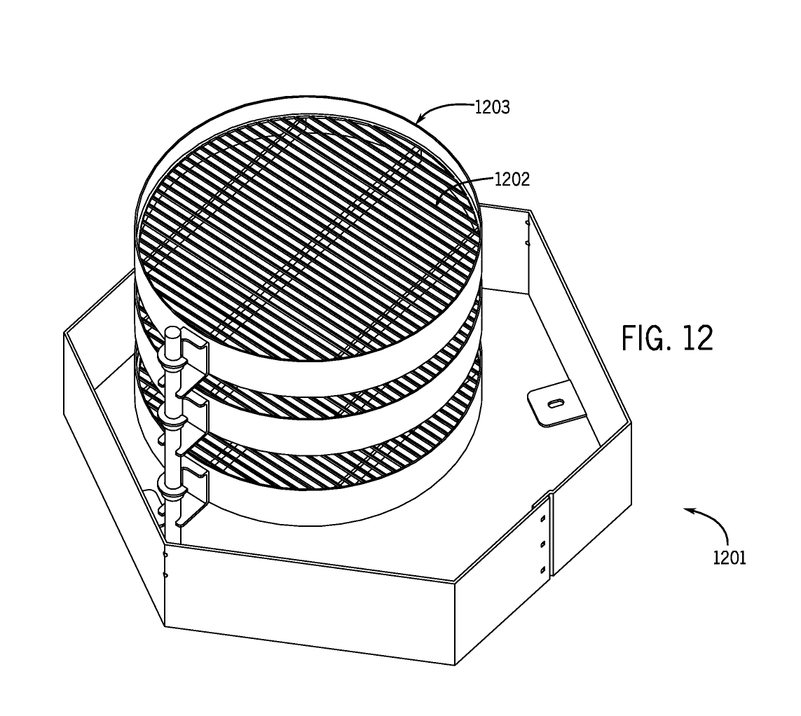

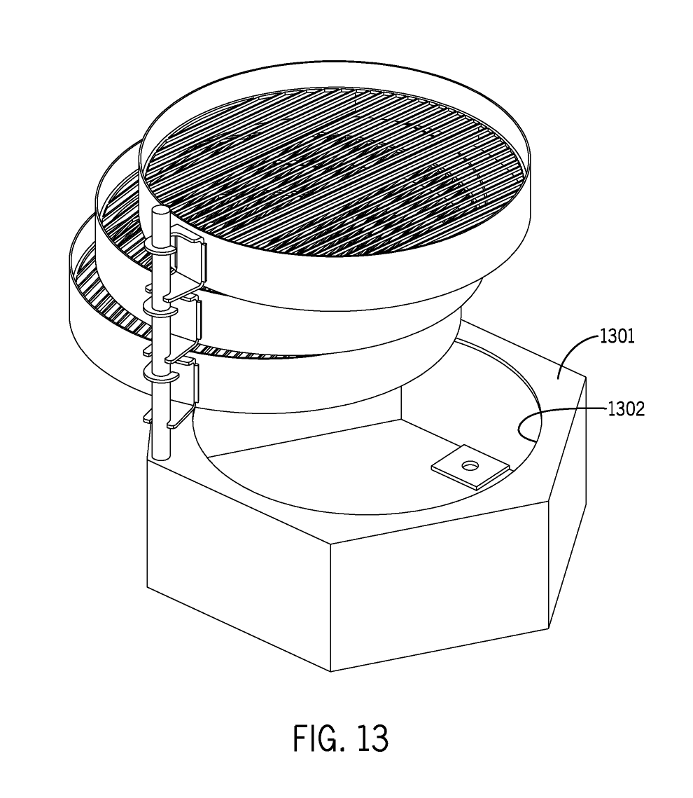

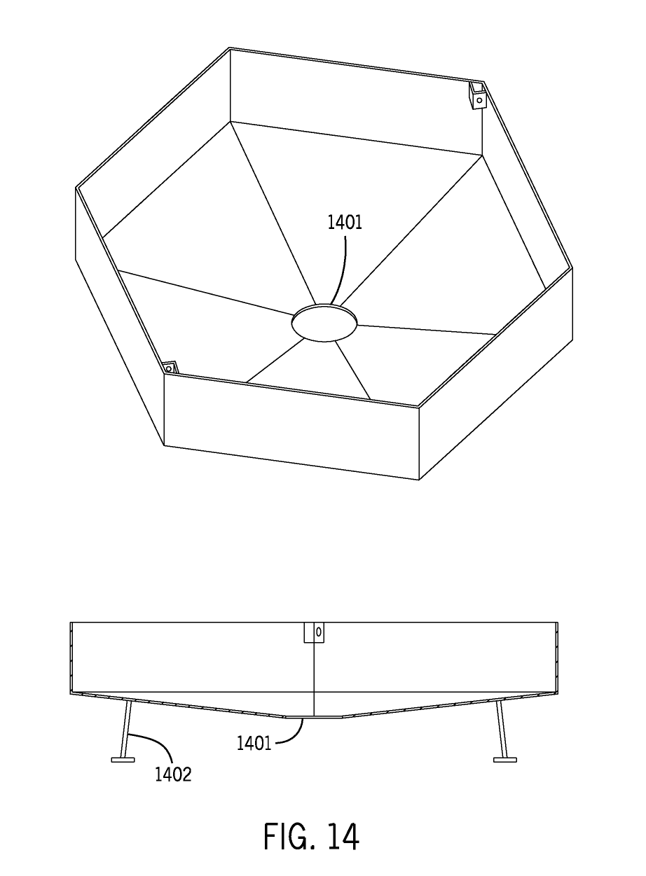

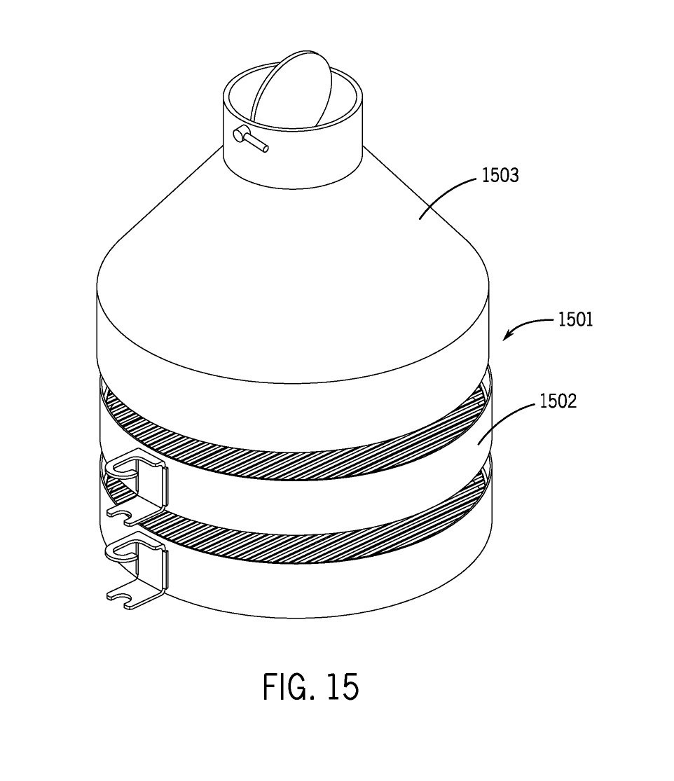

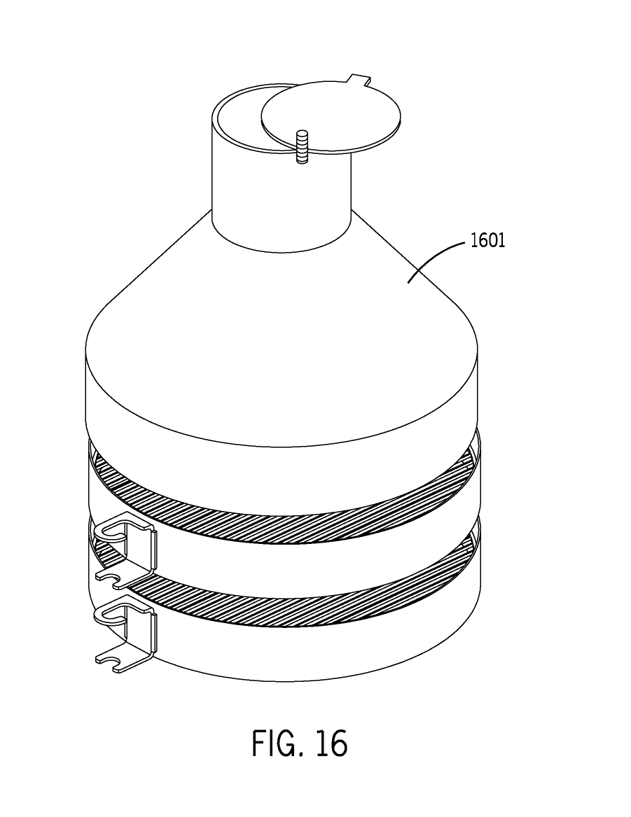

An embodiment of the apparatus comprises a quick-release mechanism and steel, although other rigid materials like cast iron or other metals may be suitable. The quick-release mechanism includes a coupling device or hinge further comprising a C-shaped article 101 601 701 that includes upper 102 and lower horizontal 103 brackets integrated with a vertical support brace 104, wherein the two horizontal brackets are adapted to engage a collar 1001 mounted on a spine 801 or a flange 902 incorporated in a spine 901. In these embodiments, the upper bracket comprises a curved hook end 105 and the lower bracket comprises an oval or semi oval-shaped end 106. In another embodiment, the curved, hook end 702 includes a more angular upper bracket 703. In addition, as shown in FIGS. 2-5, the vertical support brace of the coupling device or hinge may be adapted to include various structures to connect the hinge to a component. Such structures may include a slot or plurality of slots 201 501 to accommodate hooks, a keyhole connection 301 to accommodate a corresponding male key, or holes 401 to allow a component to bolt to the coupling device. The inner radial circumference of both the hook 105 and oval 106 are slightly larger than the outside circumference of the spine 802 903 904 so the hook and oval can partially encircle the spine when engaged with the spine.

Another embodiment includes a spine further comprising a plurality of notches or circumferential grooves 901, which are adapted to receive the hook end 105 702 of the coupling device 101 701 in a manner functionally equivalent to the aforementioned collar 1001. In this embodiment, the semi oval-shaped end 106 704 frictionally engages the larger diameter 903 of the spine 901.

The coupling device or hinge engages the spine by resting upon a collar 1001 attachable to the spine 801 or the flange 902 created by the circumferential groove 905. In one embodiment, the collar comprises a split collar with an adjustable inner circumference 1001. Said inner circumference 1002 can be adjusted to slightly larger than the outside circumference of the spine 802 so the collar can slip over or around the spine. The collar 1001 is adapted to frictionally engage the spine 802, for example by tightening, thereby allowing the user to position the collar along a length of the spine of the user's choosing. In another embodiment, the user may employ a plurality of collars. In another embodiment, the collar comprises a sleeve with an inner diameter slightly larger than the outer diameter of the spine so the sleeve can slip over the spine and rest upon a side, the ground, or the collar of a sleeve placed below. In this embodiment, the user may employ sleeves of different lengths to adjust the relative height of the cooking supports above the heat source.

The spine 801 901 is essentially a rod comprising metal, like steel, or other suitable metals. Another embodiment of the spine may comprise at least one integrated collar positioned along an axis perpendicular to the vertical axis of the spine. A further embodiment may comprise a circumferentially grooved rod 901 wherein the circumference of the grooved section 904 is smaller than an adapted circumference of the hook end 105 702.

In the aforementioned embodiments, the hook end of the coupling device or hinge rests upon the collar or flange formed by the circumferential groove and the oval-shaped end is frictionally engaged with the spine. When so engaged with the spine, the device or hinge is adapted to rotate around a vertical axis of the spine. Thus, any component attached to the device or hinge can also be rotated around a vertical axis of the spine or positioned along a length of the spine.

When utilized as a component of an outdoor cooking apparatus 1201, the coupling device or hinge provides vertical and rotatable movement of a component or support 1203 attachable to the device or hinge in relationship to a heat source.

The heat source area may comprise a heat containment area or structure 1101 further comprising circular, rectangular or hexagon 1101 configurations comprising identical sections 1102 1103 that can be assembled and disassembled to make the cooking apparatus portable. Those skilled in the art will appreciate that other shapes may be suitable and equivalent to the aforementioned configurations. An embodiment of the heat containment structure 1101 includes at least one anchor 1104, preferably a plurality of anchors adapted to accommodate a stake or nail in an opening 1105 through the anchor and into the ground to secure the heat containment structure to the ground. Another embodiment of the heat containment structure comprises an overhang 1301 on the top side of the structure defining a circular opening 1302. A further embodiment of the heat containment structure comprises a partially enclosed bottom 1401 and support legs 1402.

The heat containment structure, regardless of the shape or configuration, might define a raised perimeter 1106 confining a heat source. The raised perimeter also impedes the heat source, as in the case of loose wood or charcoal, from falling or moving outside the perimeter. The heat source might include an electrical source, burning wood or charcoal, or ignited fossil fuel like propane gas. Those skilled in the art will appreciate that other heat sources may be suitable and equivalent to practice the invention disclosed herein.

The heat containment structure 1101 is further adapted to mount and support 1107 a spine 801 901 and may be configured to mount the spine at a plurality of locations 1107 1107a on the structure. In the embodiment of a cooking apparatus, the spine is essentially a metal rod, like steel, or other suitable material. In one embodiment, the heat containment structure includes a plurality of spine mounts, each adapted to receive, retain, and support a spine.

As discussed before, the hook of the coupling device 101 701 may rest upon a collar 1001 engaged with the spine. When the hook is so positioned, the oval end of the device rests upon and is frictionally engaged with the spine. When the hook and oval ends are so engaged, any component operably connected to the coupling device, like, by way of non-limiting example only, a support 1203 for a cooking surface 1202, can be easily positioned at a desired height along the spine by adjusting the position of the collar. Such a cooking support 1203 also can be easily rotated around a vertical axis of the spine allowing the support and surface to rotate away from and over the heat source.

An embodiment of the cooking support 1203 includes a plurality of such supports separately attachable or connectable to the spine. The cooking support may comprise a ring 1203, which is attached or attachable to the coupling hinge. The ring of the cooking support may be further adapted to comprise an inner-ring comprising a lip that traverses the inner circumference of the ring, or a plurality of smaller lips equally dispersed within the circumference of the ring, or a support bar or plurality of bars traversing the inner diameter of the ring upon which a cooking surface 1202 may be securely placed within the ring 1203. In one embodiment, multiple cooking supports can be adapted to vertically funnel and partially trap smoke and heat to speed cooking and/or create a smoking effect 1501. In this embodiment, the cooking support at the top of the smoking column 1502 may be adapted to accommodate a lid 1503 1601 to trap heat and/or smoke to create a consistent cooking temperature like an oven. By way of non-limiting example only, suitable cooking surfaces include a grate, a wok, a griddle, a skillet, rotisserie, an arm comprising a hook, and/or a Dutch oven.

Embodiments of the cooking apparatus may include other features like a ring or tube that traverses the circumference of the heat containment structure and adapted as a footrest. The heat containment structure may also include a wind deflector or shield, and/or air intakes carved out of the structure to channel air towards the heat source.

It is to be understood that the above description is intended to be illustrative and not restrictive. For example, the above-described embodiments and variations may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. An outdoor cooking apparatus comprising:
a. a heat source area;
b. at least one vertically oriented spine;
c. a coupling device or hinge further comprising a rigid material; a horizontally oriented upper bracket, wherein the upper bracket comprises a curved, semi-oval hook end; a vertically oriented support brace, wherein the support brace includes structure selected from the group consisting of: at least one slot to accommodate a hook; at least one keyhole to accommodate a corresponding male key; and at least one hole to accommodate a bolt; and a horizontally oriented lower bracket, wherein the lower bracket comprises a curved, semi-oval end; and
d. at least one cooking support adapted to be attached or attachable to the coupling device and operably connected to the spine and further adapted for efficient attachment and detachment of the cooking support to and from the spine and also adapted for rotatable movement around a vertical axis of the spine and vertical movement up and down a vertical length of the spine to provide vertical and lateral movement of the cooking support over, near, or away from the heat source.

2. The outdoor cooking apparatus of claim 1, wherein the apparatus comprises metal, including steel or cast iron.

3. The outdoor cooking apparatus of claim 1, wherein the heat source area defines a perimeter.

4. The outdoor cooking apparatus of claim 3, wherein the perimeter defines a heat containment structure.

5. The outdoor cooking apparatus of claim 4, wherein the heat containment structure comprises a hexagon shape.

6. The outdoor cooking apparatus of claim 5, wherein the heat containment structure comprises at least one anchor comprising a longitudinal flange and an opening therein adapted to retain a stake to secure the heat containment structure to the ground.

7. The outdoor cooking apparatus of claim 4, wherein the spine is attachable to the heat containment structure.

8. The outdoor cooking apparatus of claim 4, wherein a plurality of spines are attachable to the heat containment structure.

9. The outdoor cooking apparatus of claim 1, wherein the spine is attachable to the ground.

10. The outdoor cooking apparatus of claim 9, wherein the spine includes a stake adapted to be embedded in the ground.

11. The outdoor cooking apparatus of claim 1, wherein the at least one cooking support includes a plurality of cooking supports.

12. The outdoor cooking apparatus of claim 11, wherein the plurality of cooking supports further comprise a plurality of cooking surfaces.

13. The outdoor cooking apparatus of claim 12, wherein the plurality of cooking surfaces includes surfaces selected from the group consisting of: a grate, a wok, a griddle, a skillet, a rotisserie, an arm comprising a hook, or a Dutch oven.

14. The outdoor cooking apparatus of claim 1, wherein the apparatus further comprises at least one collar adapted to frictionally connect to the spine.

15. The outdoor cooking apparatus of claim 14, wherein the collar is adapted to frictionally support the upper bracket.

16. The outdoor cooking apparatus of claim 14, wherein the apparatus includes a plurality of collars.

17. The outdoor cooking apparatus of claim 16, wherein the collar is adapted to frictionally support the upper bracket.

18. The outdoor cooking apparatus of claim 1, wherein the spine includes a least one circumferential groove.

19. The outdoor cooking apparatus of claim 18, wherein the spine includes a plurality of circumferential grooves.

20. An outdoor cooking apparatus comprising a coupling device or hinge further comprising a rigid material; a horizontally oriented upper bracket, wherein the upper bracket comprises a curved, semi-oval hook end; a vertically oriented support brace, wherein the support brace includes structure selected from the group consisting of at least one slot to accommodate a hook; at least one keyhole to accommodate a corresponding male key; and at least one hole to accommodate a bolt; and a horizontally oriented lower bracket, wherein the lower bracket comprises a curved, semi-oval end.
